(19) United States
(12) Patent Application Publication
(10) Pub. No.: US 2008/0152772 A1
(43) Pub. Date: Jun. 26, 2008

(54) Thermoformable Packaging Material Exhibiting Shrinking Properties

(75) Inventors: Walter Bernig, Durach (DE); Ralph Seelbach, Kempten (DE); Bernard Dujardin, Brussel (BE)

Correspondence Address: NORRIS, MCLAUGHLIN & MARCUS, P.A., 875 THIRD AVE, 18TH FLOOR, NEW YORK, NY, 10022, US

(73) Assignee: CFS KEMPTEN GMBH, KEMPTEN (DE)

(21) Appl. No.: 11/817,278

(22) PCT Filed: Mar. 1, 2006
(86) PCT No.: PCT/EP06/01870

§ 371 Date: Jan. 7, 2008

(30) Foreign Application Priority Data
Mar. 1, 2005 (DE) 10 2005 009 868.1
Mar. 1, 2005 (DE) 10 2005 009 870.3
Apr. 18, 2005 (DE) 10 2005 017 937.1

(51) Int. Cl. B32B 27/32; B65B 47/02; B65B 9/04; B65D 65/40; B29C 51/42

(52) U.S. Cl. 426/410; 428/200; 428/34.9; 156/84; 156/498

(57) ABSTRACT

Themoformable multilayer film having a longitudinal and transversal thermoshrinkability equal to or greater than 20%, which thermoshrinkability is not substantially influenced by thermoforming, and devices for producing packages from the thermoformable multilayer film.

The invention relates to multilayer films which are thermoformable and simultaneously heat-shrinkable, the heat-shrinkability being virtually unaffected by thermoforming, as well as at least to packaging trays produced therefrom and corresponding packages produced on an adapted packaging machine.

These days, foodstuffs are ever more frequently offered for sale in plastics packages, which comprise a packaging tray, in which the foodstuffs are placed, and a lidding film, with which the packaging tray is sealed.

The packaging trays are conventionally produced from a thermoformable multilayer film by thermoforming with exposure to heat. After introduction of the product to be packaged, the packaging tray is also sealed with the lidding film with exposure to heat, i.e. by heat sealing.

Packages of this type are known, in which the lidding film is a heat-shrinkable multilayer film.

Heat-shrinkable multilayer films are conventionally biaxially oriented and are used in the packaging of foodstuffs, in particular of perishable foodstuffs such as poultry or fresh meat, said multilayer films preferably comprising a gas- and/or aroma-tight barrier layer. Heat-shrinkable multilayer films have the property of shrinking back to their original, non-oriented dimensions if they are heated to their softening point. Biaxially oriented multilayer films are drawn in both the lengthwise and transverse directions in accordance with the process of production thereof and often exhibit heat-shrinkability (shrinkage capacity) of 35% in both the lengthwise and transverse directions.

These is a need for packages in which the film web from which the packaging tray is produced is a heat-shrinkable multilayer film. However, this is difficult to achieve. In the case of conventional packaging materials, the thermoformability of the material required to produce the packaging tray usually stands in the way of simultaneous heat-shrinkability. On the one hand, thermoforming of conventional heat-shrinkable multilayer films often leads to delamination. On the other hand, thermoforming of conventional thermoformable multilayer films results in packaging trays which do not usually exhibit any or only slight heat-shrinkability in the thermoformed areas.

Packaging materials which are thermoformable and simultaneously heat-shrinkable have particular advantages. Such packaging materials may be used to tightly enclose the packaged products, in particular if both the packaging tray and the lidding film are formed from a heat-shrinkable material. Such packaging materials are subject to particular requirements with regard to their thermal and mechanical properties. For instance, it should be possible to initiate the shrinking process only after formation of the packaging tray by thermoforming and sealing with the lidding film, since in this way controlled, at least partial enclosure of the product to be packaged may be achieved. Accordingly, on the one hand, it should be possible for thermoforming to yield the packaging tray to proceed without the shrinking process being initiated with the concomitant exposure to heat. On the other hand, sealing, i.e. thermal welding of the packaging tray to the lidding film should also be able to proceed without the shrinking process being initiated with the concomitant exposure to heat.

The object of the present invention is to provide a packaging material which has advantages over prior art packaging materials. In particular, the packaging material should be capable of being thermoformed to yield a packaging tray and sealed to the lidding film after introduction of the product to be packaged without significant shrinkage of the packaging material having taken place up to this point. Only then should the shrinking process be initiated by conventional measures such as exposure to heat, whereby the closed package lies at least in part closely against the product to be packaged. After thermoforming and heat-sealing, on the one hand, sufficient interlayer adhesion should be ensured and, on the other hand, sufficient heat-shrinkability should also still be present.

This object may be achieved by a thermoformable multilayer film with heat-shrinkability in the lengthwise and transverse directions of in each case at least 20%, said heat-shrinkability being substantially unaffected by thermoforming. Preferably, the heat-shrinkability of the multilayer films according to the invention amounts in the lengthwise and transverse directions in each case to at least 25%, more preferably at least 30%, still more preferably at least 35%, most preferably at least 40% and in particular at least 45%.

It has surprisingly been found that multilayer films may be produced which, on the one hand, are thermoformable and also still exhibit sufficient interlayer adhesion after thermoforming and which, on the other hand, are heat-shrinkable, the exposure to heat having virtually no effect on this property in the course of thermoforming using suitable equipment.

“Substantially unaffected” or “virtually no effect” preferably means for the purposes of the description that the heat-shrinkability of the multilayer film according to the invention prior to thermoforming and the heat-shrinkability of the multilayer film according to the invention after thermoforming are only slightly or virtually unchanged. Should thermoforming be accompanied by a reduction in heat-shrinkability, this preferably amounts to less than 10%, more preferably less than 7.5% and in particular less than 5%, relative to the original heat-shrinkability of the multilayer film.

Preferably, the multilayer film according to the invention is heat-sealable, the heat-shrinkability of the multilayer film preferably also being substantially unaffected by heat-sealing.

In one embodiment, the invention relates to a thermoformable heat-shrinkable multilayer film, comprising the following layers:
a backing layer (T) based on at least one thermoplastic polymer;
a coupling agent layer (H₁) based on at least one polymer with a melt flow index MFI in the range from 0.1 to 2.0 g/10 min, determined to DIN ISO 1133 at 190° C. and 2.16 kg, its layer thickness being greater than the layer thickness of at least one of the layers directly adjoining the coupling agent layer (H₁);
optionally an oxygen-tight barrier layer (B);
optionally a coupling agent layer (H₂) based on at least one polymer with a melt flow index MFI in the range from 0.1 to 2.0 g/10 min, determined to DIN ISO 1133 at 190° C. and 2.16 kg, its layer thickness being greater than the layer thickness of at least one of the layers directly adjoining the coupling agent layer (H₂); and
a sealing layer (S) which forms one of the two surface layers of the multilayer film and is based on at least one thermoplastic polymer.

The sequence of the individual layers within the multilayer film preferably corresponds to the order in which they are stated in the above list, i.e. (T)//(H₁)//(B)//(H₂)//(S). The symbol “//” denotes the interface between two adjacent layers. It is not absolutely necessary for two layers separated by “//” to succeed one another directly, i.e. to touch one another—it is also possible for further layers to be inserted. Multilayer films of the layer sequences (T)//(H₁)//(S) and (T)/(H₁)//(B)//(H₂)//(S) are particularly preferred according to the invention.

Preferably, the melt flow index MFI of the coupling agent layer (H₁) and the optionally present coupling agent layer (H₂) lies, identically or differently, in the range from 0.2 to 1.9 g/10 min, more preferably 0.3 to 1.8 g/10 min, still more preferably 0.4 to 1.7 g/10 min, most preferably 0.5 to 1.6 g/10 min and in particular 0.6 to 1.5 g/10 min, determined to DIN ISO 1133 at 190° C. and 2.16 kg.

In principle, various polymers, copolymers or mixtures thereof may be considered for the coupling agent layers (H₁) and optionally (H₂). Preferably, the coupling agent layer (H₁) and the optionally present coupling agent layer (H₂) are based, identically or differently, on an ethylene/vinyl acetate copolymer. Particularly preferably, the ethylene/vinyl acetate copolymer is, identically or differently, one with a vinyl acetate content in the range from 3 to 18 mol %, more preferably 5 to 17 mol %, most preferably 10 to 16 mol %, determined to ASTM E-168. It is possible for the ethylene/vinyl acetate copolymer to be further modified. In this context, mention should be made of acrylic acid-/acrylate-modified ethylene/vinyl acetate copolymer, anhydride-modified ethylene/vinyl acetate copolymer or a polymer blend containing at least one of the above-stated polymers.

In a preferred embodiment, the layer thickness of the coupling agent layer (H₁) is in each case greater than the layer thickness of the two layers directly adjoining the coupling agent layer (H₁), and/or the layer thickness of the optionally present coupling agent layer (H₂) is in each case greater than the layer thickness of the two layers directly adjoining the coupling agent layer (H₂). It has surprisingly been found that, through suitable selection of the layer thickness of the coupling agent layer (H₁) and the optionally present coupling agent layer (H₂), it is possible to avoid delamination of layers in each case bonded together by the coupling agent layer in the course of thermoforming.

Particularly preferably, the coupling agent layer (H₁) and the optionally present coupling agent layer (H₂), identically or differently, exhibit a film thickness of at least 20 μm, more preferably at least 25 μm, still more preferably at least 30 μm, most preferably at least 35 μm and in particular at least 40 μm.

In a preferred embodiment of the multilayer film according to the invention, the backing layer (T) forms one of the two surface layers of the multilayer film.

Preferably, the backing layer (T) of the multilayer film according to the invention is based on at least one polyolefin, olefin copolymer, polyester or a mixture thereof. Preferably, the polymer is at least one polymer selected from the group consisting of polyethylene, ethylene copolymer, polypropylene and propylene copolymer.

Preferred polyolefins are polyethylene, in particular polyethylene with a density of at most 0.92 g/cm³, polypropylene (PP), ethylene copolymer, in particular ethylene/vinyl acetate copolymer and/or propylene copolymer. Particularly preferably, the backing layer (T) is based on polypropylene, a propylene copolymer (in particular a propylene random copolymer or a propylene block copolymer) or a mixture thereof.

The backing layer (T) may contain conventional additives, such as for example antiblocking agents, antistatic agents and/or slip agents.

Preferably, the layer thickness of the backing layer (T) is less than 50%, preferably less than 25%, of the overall film thickness of the multilayer film according to the invention. Preferably, the backing layer (T) has a layer thickness in the range from 5 to 100 μm, more preferably 6 to 75 μm, still more preferably 7 to 50 μm, most preferably 8 to 35 μm and in particular 9 to 15 μm.

The sealing layer (S) of the multilayer film according to the invention is preferably based at least on a polymer selected from the group consisting of polyolefins, olefin copolymers, polyalkyl methacrylates, alkyl methacrylate copolymers, ionomers, or a mixture thereof.

In a preferred embodiment, the sealing layer (S)) is based on at least one polyethylene selected from the group consisting of polyethylene produced by means of metallocenes (m-PE), high density polyethylene (HDPE), low density polyethylene (LDPE) and linear low density polyethylene (LLDPE). Particularly preferably, the sealing layer (S) is based on m-PE, LDPE, LLDPE or a mixture thereof. Preferably, the sealing layer (S) is based on at least one polyethylene, particularly preferably on a mixture of m-PE (metallocene polyethylene), particularly preferably with a density greater than or equal to 0.9 g/cm³, and a linear low density polyethylene (LLDPE), preferably with a density greater than or equal to 0.9 g/cm³. In a preferred embodiment, the mixture contains 70 to 85 wt. % of m-PE, 30 to 15 wt. % of LLDPE and optionally up to 5 wt. % of conventional additives, in each case relative to the total weight of the sealing layer (S). The sealing layer (S) may also be based on at least one polypropylene and/or propylene copolymer, preferably a propylene/ethylene copolymer. In a preferred embodiment, the heat sealing-layer (S) is based on at least one acrylic acid copolymer, in particular ionomer, i.e. on an ethylene/acrylic acid copolymer or ethylene/methacrylic acid copolymer, which are present in each case at least in part, preferably up to 35%, as a salt, preferably as an Na or Zn salt (preferably Surlyn®, e.g. at least in part as zinc salt). Sealing temperatures preferably lie in the range from 100° C. to 140° C. The melting temperature of the sealing layer (S) amounts preferably to from 90 to 140° C., particularly preferably 95° C. to 130° C. The sealing layer (S) may be provided with conventional auxiliary substances such as antistatic agents, slip agents, antiblocking agents, antifogging agents and/or spacers.

The layer thickness of the sealing layer (S) preferably amounts to at most 25% of the overall film thickness of the multilayer film according to the invention. Preferably, the sealing layer (S) has a layer thickness in the range of from 5 to 25 μm, more preferably 7.5 to 20 μm and in particular 10 to 20 μm.

In a preferred embodiment, the multilayer film according to the invention comprises, in addition to the backing layer (T), the coupling agent layer (H₁) and the sealing layer (S), an oxygen-tight barrier layer (B) and/or a coupling agent layer (H₂), preferably both an oxygen-tight barrier layer (B) and a coupling agent layer (H₂).

The barrier layer (B) is preferably based on polyvinylidene chloride, a vinylidene chloride copolymer, in particular a vinylidene chloride/methacrylic acid copolymer with up to 10 wt. % methacrylic acid units or a mixture thereof. Ethylene/vinyl alcohol copolymer (EVOH) is in principle also suitable. Suitable methods for measuring oxygen-tightness are known to a person skilled in the art. Oxygen permeability amounts preferably to at most 70, more preferably at most 50, still more preferably at most 40, most preferably at most 30 and in particular at most 20 [cm³m⁻²d⁻¹ bar O₂], determined to DIN 53380. Preferably, the thickness of the barrier layer is so selected that this barrier effect is achieved. In this respect, it should be taken into account that, as a result of thermoforming, film thickness is reduced in the thermoformed areas of the multilayer film. Preferably, oxygen permeability amounts to the above-stated values even after thermoforming.

In a preferred embodiment, the barrier layer (B) has a layer thickness in the range from 5 to 50 μm, more preferably 7.5 to 25 μm and in particular 9 to 15 μm.

In principle, the multilayer film according to the invention may additionally contain conventional additional or auxiliary substances independently in one or more layers. To vary the surface slip properties of the multilayer film, at least one layer may contain slip agents. The slip agents should preferably be contained in the backing layer (T) and/or the sealing layer (S), but may additionally also be contained in at least one of the layers therebetween. In addition, the multilayer film may contain conventional stabilisers, antioxidants, plasticisers, processing aids, UV absorbers, fillers, flame retardants, antistatic agents, etc. in one or more layers. Such substances are known to a person skilled in the art.

Particularly preferred embodiments of the multilayer film according to the invention are listed in the following Table, the multilayer film having the structure (T)//(H₁)//(B)//(H₂)//(S):

| | | Layer thickness | | |
|---|---|---|---|---|
| | Composition | | more | in |
| | comprising | preferred | preferred | particular |
| (T) | Polyethylene and/or | 5 to 100 μm | 7 to 50 μm | 9 to 15 μm |
| | polypropylene | | | |
| (H₁) | Ethylene/vinyl acetate | at least | at least | at least |
| | copolymer | 20 μm | 25 μm | 30 μm |
| (B) | Polyvinylidene | 5 to 50 μm | 7.5 to 25 μm | 9 to 15 μm |
| | chloride and/or | | | |
| | vinylidene | | | |
| | chloride/methacrylic | | | |
| | acid copolymer | | | |
| (H₂) | Ethylene/vinyl acetate | at least | at least | at least |
| | copolymer | 20 μm | 25 μm | 30 μm |
| (S) | Polyethylene, ethylene | 5 to 25 μm | 7.5 to 20 μm | 10 to 20 μm |
| | copolymer, | | | |
| | polypropylene, | | | |
| | propylene copolymer | | | |
| | and/or ionomer | | | |

A particularly preferred multilayer film according to the invention has the following structure:

| Layer | Thickness | Composition |
|---|---|---|
| (T) | 15 ± 5 μm | Polypropylene |
| (H₁) | 36 ± 10 μm | Ethylene/vinyl acetate |
| | | copolymer |
| (B) | 12 ± 5 μm | Polyvinylidene chloride |
| (H₂) | 36 ± 10 μm | Ethylene/vinyl acetate |
| | | copolymer |
| (S) | 10 ± 5 μm | Mixture of m-PE and |
| | | LLDPE |

The multilayer film according to the invention may contain further layers, for example layers based, identically or differently, on at least one polymer selected from the group consisting of polyolefins, olefin copolymers and polyesters.

The multilayer film according to the invention may be printed, wherein at least one layer of the multilayer film may be printed and/or coloured by the addition of additives such as organic or inorganic dyes and pigments.

In a preferred embodiment, the multilayer film according to the invention is transparent. For the purposes of the invention, the term “transparent” means that a packaged product may be looked at with the naked eye through the thermoformable multilayer film. Transparency is preferably quantified with the assistance of densitometers. Such methods are familiar to a person skilled in the art. Preferably, haze may be measured as an optical value as a measure of transparency. Measurement of haze is preferably performed to ASTM test standard D 1003-61m, procedure A, after calibration of the measuring instrument using haze standards of between 0.3 and 34% haze. One example of a suitable measuring instrument is a haze meter made by Byk-Gardner with an integrating sphere, said haze meter permitting integrated measurement of diffuse light transmittance values over a solid angle of from 8° to 160°. After thermoforming, the multilayer films according to the invention preferably exhibit haze, determined according to the above-described method, of less than 20%, more preferably less than 18%, still more preferably less than 15%, most preferably less than 10% and in particular less than 8%. Thermoforming preferably has no or only a slight effect on the optical properties of the multilayer films according to the invention (relative to material of identical thickness).

The multilayer film according to the invention is thermoformable. For the purposes of the invention, the term “thermoformable” defines a material which may be “thermoformed” under exposure to heat on a suitable apparatus, i.e. may be shaped under exposure to pressure (and/or a vacuum), for example to yield an open receptacle, preferably a tray. The material is a material having thermoplastic properties, such that it is deformable when heated but exhibits sufficient dimensional stability at room temperature, such that the shape (e.g. tray) predetermined by thermoforming is initially retained until the shrinking process is initiated by the input of heat.

The multilayer film according to the invention is heat-shrinkable. To this end, it is preferably biaxially oriented, wherein it preferably has a draw ratio in the lengthwise direction (i.e. in the machine direction) of 1:5 to 1:3, preferably of 1:3.5 to 1:4.5 and in transverse direction of 1:5 to 1:3, preferably of 1:3.5 to 1:4.5. The layer thickness details given in the description should be understood as the layer thickness of the respective layer of the multilayer film according to the invention after lengthwise and transverse orientation.

In the case of the multilayer film according to the invention, one or all of the layers may be crosslinked together to improve their resistance to wear and/or puncture. This crosslinking may be achieved, for example, by using β radiation (high-energy electrons). The radiation source may be any desired electron beam generator which operates in a range of from roughly 150 kV to roughly 300 kV. Irradiation is conventionally carried out at a dose of up to 60 kGy, a preferred dose lying in the range of from 2 to 15 Mrad.

The multilayer film according to the invention preferably has a total film thickness in the range of from 50 to 250 μm, more preferably 60 to 200 μm, still more preferably 70 to 170 μm, most preferably 80 to 150 and in particular 90 to 130 μm.

Production of the multilayer film according to the invention may comprise as a sub-step a blowing, flat film, coating, extrusion, coextrusion or corresponding coating or laminating process. Combinations of these processes are also possible. Such processes are known to a person skilled in the art. In this connection, reference may be made for example to A. L. Brody, K. S. Marsh, The Wiley Encyclopedia of Packaging Technology, Wiley-Interscience, 2nd edition (1997); W. Soroka, Fundamentals of Packaging Technology, Institute of Packaging Professionals (1995); J. Nentwig, Kunststoff-Folien, Hanser Fachbuch (2000); and S.E.M. Selke, Understanding Plastics Packaging Technology (Hanser Understanding Books), Hanser Gardner Publications (1997). Known production installations conventional in the art may be considered. In the case of flat film coextrusion, installations are preferably used which permit rapid cooling, such as large chill rolls.

The polymers used for the layer structure of the multilayer film are commercially obtainable and described sufficiently in the prior art. To produce multilayer films according to the invention, they are conventionally mixed in the form of pellets or granules so far as is necessary in conventional mixers and further processed by melting preferably with the assistance of extruders. If the multilayer film is intended for the packaging of foodstuffs, all the polymers used must be approved for use in food packages.

The multilayer film according to the invention is extremely well suited to the packaging of goods, preferably of foodstuffs, particularly preferably of perishable foodstuffs. The multilayer film is suitable, for example, for the packaging of foodstuffs such as meat, fish, vegetables, fruit, dairy products, smoked goods, ready meals, grain, cereals, bread and bakery products, and also of other goods, such as for example medical products.

The present invention also provides the use a thermoformable, heat-shrinkable, multilayer film, preferably the one according to the invention, for the production of a package or a packaging tray, preferably for a foodstuff. When producing a package, a heat-shrinkable packaging tray is preferably produced first from the multilayer film by thermoforming. Because of the particular properties of the multilayer film, the heat-shrinkability, in particular even in the thermoformed area of the multilayer film, is preferably substantially unaffected by thermoforming.

In addition, the invention relates to a method of producing a thermoformed, heat-shrinkable packaging tray comprising thermoforming a thermoformable, heat-shrinkable, multilayer film, preferably the one according to the invention, under conditions in which heat-shrinkability is substantially unaffected in the thermoformed area.

In the preferred thermoforming process, various thermoforming ratios may be implemented, for example from 1:2 to 1:5, preferably 1:4.5. It is known to a person skilled in the art that the individual layer thickness of the multilayer film may be adapted to the intended thermoforming ratio, so that the material thickness is still sufficient afterwards even in the thermoformed areas.

The invention also relates to a thermoformed, heat-shrinkable packaging tray, which may be obtained by the above-described method.

The multilayer film according to the invention may be thermoformed on conventional apparatus. Preferably, however, to thermoform the multilayer film according to the invention, i.e. to form a thermoformed, heat-shrinkable packaging tray, the thermoforming device described below is used to produce thermoformed packaging trays. In this respect, the property of the multilayer film according to the invention that its heat-shrinkability is substantially unaffected by thermoforming, is preferably also associated with thermoforming by means of this thermoforming device described below.

### Thermoforming Device for the Production of Thermoformed Packaging Trays:

This is a thermoforming device for producing thermoformed packaging trays according to the invention from a film web according to the invention using a thermoforming tool, the thermoforming tool being cooled during thermoforming. Preferably, the thermoforming tool comprises cooling means for effecting cooling during thermoforming. Such cooling means may be cooling ducts, which are arranged in the area of the thermoforming tool and through which there circulates a cooling medium, for example a cooling liquid or a cooling gas.

Preferably, the devices comprises holding means, such that the film web may be clamped between the holding means and the thermoforming tool. Preferably, the film web is fixed with the holding means before thermoforming takes place. In a preferred embodiment, this holding means is likewise provided with a cooling means, which may be connected to the same cooling means circuit as the thermoforming tool or to another cooling circuit. A particularly suitable cooling means is one which is also used, for example, in refrigerators and the like.

Preferably, at least one cooling means circuit is controlled, for example temperature-controlled, in such a way that the thermoforming tool and/or the holding means is/are always at a virtually constant temperature.

It is also preferable for the thermoforming device to comprise a heating means, particularly preferably a heating plate, with which the film web may be heated up, in particular prior to thermoforming. Once the film web has been heated up and particularly preferably prior to thermoforming, the heating means is moved away again from the film web and/or switched off, in order to avoid overheating the film web and to prevent too much heat from having to be dissipated during cooling of the thermoforming tool or of the holding means. Preferably, heating proceeds in a locally highly targeted manner, such that only the desired areas are heated, and in particular not the areas which have later to be cooled. The person skilled in the art will recognise that heating and cooling may also proceed simultaneously, so as to prevent certain areas of the film web from also being heated during heating thereof and/or to prevent undesired heating up of these areas. Preferably, the film web is firstly heated up in part and cooled prior to and during thermoforming.

In a further preferred embodiment, the thermoforming device comprises vacuum and/or pressure means, with which the film web is pressed or drawn into the thermoforming tool, so achieving its final shape.

The thermoforming device is suitable in particular for producing packaging trays according to the invention for packages. If may preferably be a component part of a packaging machine, preferably a so-called form-film-seal packaging machine.

Using the above-described thermoforming device, the film web according to the invention is cooled during thermoforming and a thermoformed shrinkable packaging tray is so produced from a film web. Preferably, the film web is clamped in place prior to thermoforming. Also preferably, the film web is heated prior to thermoforming. Preferably, heating and cooling take place with a time offset, heating preferably taking place prior to cooling. Preferably, the film web is in part heated up prior to thermoforming and cooled during thermoforming. Thermoforming may proceed in any manner familiar to a person skilled in the art. Preferably, however, thermoforming is effected by overpressure and/or reduced pressure (vacuum).

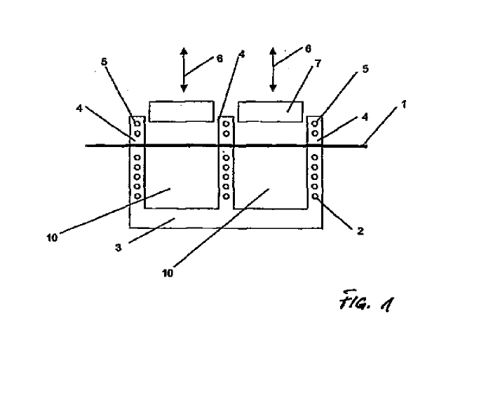

Preferred embodiments of the thermoforming device are explained in greater detail in connection with FIGS. 1 to 6.

FIG. 1 shows the device prior to thermoforming.

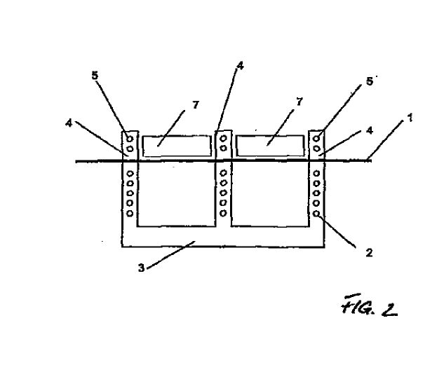

FIG. 2 shows heating of the film web according to the invention.

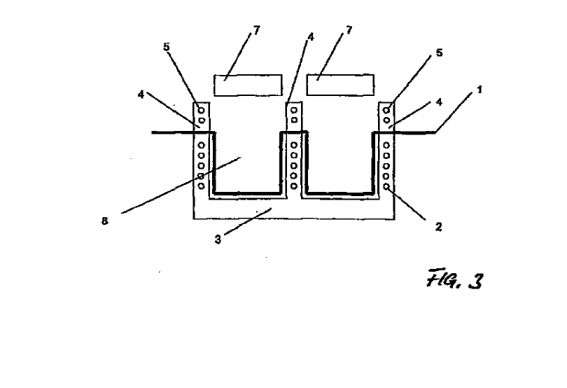

FIG. 3 shows thermoforming to yield the packaging tray.

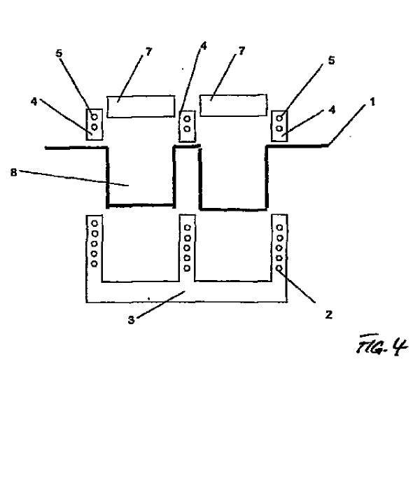

FIG. 4 shows release of the holder.

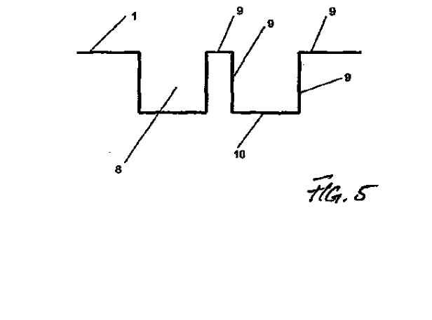

FIG. 5 shows the resultant packaging tray according to the invention.

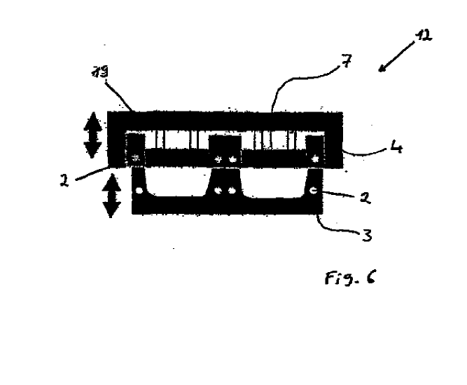

FIG. 6 shows the thermoforming device according to the invention.

FIG. 1 shows the thermoforming device, which comprises a thermoforming tool 3 with a plurality of thermoforming chambers 10. According to the invention, this thermoforming tool is cooled, cooling taking place in the present case through bore 2, through which a cooling medium is passed. Above the thermoforming tool 3, there is located the shrinkable film web 1 according to the invention, which is to be deformed and which is clamped between the thermoforming tool 3 and a clamping frame 4. The clamping frame 4 is likewise coolable in the present case by means of the bore 5, through which a coolant is passed. Above the film web 1 there are located heating plates 7, which may be raised and lowered as indicated by the double-headed arrows 6. A person skilled in the art knows that the thermoforming tool 3 is likewise vertically movable.

FIG. 2 shows heating of the film web 1 according to the invention clamped between the clamping frame 4 and the thermoforming tool 3. To this end, the heating plates 7 have been lowered, such that they are preferably in contact with the film web. The film web is heated up until it exhibits the desired temperature in the area of the heating plate. Preferably, heating takes place under time control.

As soon as the film has been sufficiently heated, the heating plates are raised again and thermoforming of the shrinkable film web 1 proceeds to produce the packaging trays 8 according to the invention (FIG. 3). In the present case, the thermoforming chambers 10 may be acted upon by a vacuum, with which the film web is deformed as illustrated. During the entire heating and thermoforming process, the thermoforming tool and the clamping frame are cooled.

As soon as the film 1 has been thermoformed to yield packaging trays 8 (FIG. 4), the thermoforming tool 3 is lowered, such that the packaging trays 8 according to the invention are demoulded from the thermoforming tool 3. The thermoforming tool is lowered far enough for it to be possible to convey the packaging trays produced away from the thermoforming area and renewed deformation of the film web 1 may take place.

FIG. 5 shows the finished packaging trays according to the invention. Due to cooling of the thermoforming mould, the package edges 9 and/or the base of the package are straight, because the film web does not shrink at all after thermoforming or shrinks only very slightly after or during thermoforming. The resultant thermoformed packaging trays are therefore heat-shrinkable, their heat-shrinkability being substantially unaffected by thermoforming.

FIG. 6 shows the thermoforming device for producing thermoformed plastics packaging trays from a shrinkable film web according to the invention. The device 12 comprises a bottom tool 3 and a top tool 19. The bottom tool 3 comprises the negative of the shape of the packaging tray to be produced. Channels 2 are incorporated into the bottom tool, through which a coolant is circulated with which the bottom tool is cooled. As indicated by the double-headed arrow, the bottom tool may be lowered or raised. The film web, not shown, extends between the bottom tool and the top tool. The top tool 19 is likewise raisable and lowerable. The same applies to the clamping frame 4 and the heating means 7. With the clamping frame, the film web is pressed against the bottom tool and clamped firmly in place, so that it can be thermoformed. The clamping frame 4 additionally also comprises channels 2, through which a coolant circulates, such that the frame of the clamping frame 4 is coolable. Cooling of the clamping frame has the advantage, in particular, that the film web located under the clamping frame is not heated and is thus stress-free. The top film is subsequently sealed onto this area. Because this area is stress-free, the seal achieved for the subsequently resultant package displays a very high level of tightness. The thermoforming device according to the invention comprises one heating element 7 per packaging tray to be produced. The film web is heated as quickly as possible with these heating elements. In order to improve heat transfer between the film web and the respective heating means, an overpressure may be generated in the area under the film web, which overpressure presses the film web against the heating means and thus improves heat transfer. A person skilled in the art will recognise that a reduced pressure may also be generated between the film web and the heating means 7, which sucks the film web against the heating means. As soon as the film web has reached its plasticisation temperature, it is pressed by the heating means 7, which then simultaneously act as a male mould, into the respective thermoforming mould and/or a reduced pressure is applied to the thermoforming mould, which sucks the film web into the thermoforming mould. This thermoforming mould is cooled, such that the film web is cooled during and/or directly after thermoforming. This cooling continues until the film web has reached a temperature at which undesired recovery of the packaging tray due to the shrinkability of the film may be ruled out.

A further aspect of the present invention therefore also relates to a thermoformed, heat-shrinkable packaging tray, preferably comprising a multilayer film according to the invention or formed from a multilayer film according to the invention, the heat-shrinkability in the thermoformed area in the lengthwise and transverse directions amounting in each case to at least 20%, preferably at least 25%, more preferably at least 30%, still more preferably at least 35%, most preferably at least 40% and in particular at least 45%.

The thermoformed, heat-shrinkable packaging tray according to the invention may advantageously be used to produce a package, preferably for a foodstuff. To this end, the product to be packaged is preferably introduced into the thermoformed, heat-shrinkable packaging tray and a heat-shrinkable or non-shrinkable lidding film is positioned over the opening of the packaging tray. Then, the optionally heat-shrinkable lidding film is heat-sealed onto the thermoformed, heat-shrinkable packaging tray under conditions in which both the heat-shrinkability of the packaging tray in the thermoformed area and the optional heat-shrinkability of the lidding film are substantially unaffected. A heat-shrinkable, multilayer film according to the invention is preferably suitable as the heat-shrinkable lidding film. Preferably, a heat-shrinkable, multilayer film according to the invention which is identical to the multilayer film from which the thermoformed packaging tray is produced is used as the lidding film.

However, it is also possible to use as the lidding film a non-shrinkable, comparatively rigid, preferably multilayer composite film of thermoplastic materials as the 2nd packaging element for closing the shrinkable packaging tray.

Particularly preferably, a multilayer film having the following sequences of layers is suitable for this purpose:
A) a base layer of optionally foamed polyolefin foam, preferably foamed propylene homo- and/or copolymers or a mixture thereof, or optionally foamed polyester, preferably foamed polyethylene terephthalate,
B) a layer consisting of at least one polyolefin or polyester of layer A)
C) optionally a bonding layer based on a polyolefin, which is preferably based on that monomer which is the main monomer of the polyolefin of layer A), or a polyester of layer A)
D) optionally a coupling agent layer,
E) optionally a gas- and/or aroma-tight barrier layer,
F) a coupling agent layer,
G) a sealable and/or peelable surface layer.

Preferably, the multilayer film is distinguished in that the total thickness of layers A) and B) is in the range from 0.5 to 2 mm and the thickness of layer B) is in the range from ⅙ to ½ the thickness of layer A).

Preferably, the total thickness of layers A) and B) is in the range from 0.6 to 1.4 mm and the thickness of layer B) is in the range from ⅙ to ⅓ of the thickness of layer A).

Layer A) is preferably foamed and preferably consists of at least one polyolefin, particularly preferably of foamed propylene homo and/or copolymer, since these materials, being of low thickness and low density, already have the necessary flexural strength. It is also possible to use mixtures of polyolefins to produce foam layer A). A particularly suitable mixture consists of polypropylene with long-chain branching and thus high melt strength and a propylene/ethylene copolymer, such as for example a heterophase propylene/ethylene block copolymer. Of particular suitability is a mixture of a polypropylene with long-chain branching and a melt flow index MFI in the range from 1.4 to 4.2 g/10 min and a heterophase propylene/ethylene block copolymer in a mixing ratio of 1:1.

Foam layers of polyolefins, preferably of polypropylene optionally in a mixture with polyolefin copolymers, preferably propylene/ethylene copolymers, which are used to produce packages according to the invention preferably have a density of 0.1 to 0.8 g/cm³, particularly preferably 0.25 to 0.5 g/cm³, and exhibit a cell count of 75 to 300 cells/mm³. Density and cell count may be varied by process parameters, such as for example the extrusion temperature or other process parameters, during the preferred production of the foam layer by extrusion and expansion. In the same way, a foamed polyester layer A) may be produced.

Layer (B) of compact polyolefin consists substantially preferably of a polypropylene of the foamed base layer A). If this base layer consists of foamed polypropylene or a foamed mixture of polypropylene and propylene/ethylene copolymer, the compact polyolefin layer (B) preferably consists of polypropylene or a propylene/ethylene copolymer. A heterophase propylene/ethylene block copolymer is particularly preferred. The melt flow index (MFI) of the polyolefins used to produce layer B) is preferably in the range from 1.8 to 5.5 g/10 min; if layer A) consists of foamed polyester, this polyester is used to produce layer B). The thickness of layer B) amounts to ⅙ to ½, particularly preferably to ⅛ to ⅓ of the thickness of layer A).

Layer C) is present, provided that layers D) to G) are prefabricated by coextrusion, preferably by blown film coextrusion, and are to be bonded to the other layers. Layer C) is based on a polyolefin, which has preferably been produced from a monomer, which is also the main monomer of the polyolefins of foam layer A), or on the polyester of layer A). If, therefore, layer A) consists of a foamed polypropylene and optionally a propylene/ethylene copolymer, layer C) may consist of polypropylene, which is optionally grafted with maleic anhydride. Copolymers of ethylene/vinyl acetate may also be used as the material of layer C). The thickness of layer (C) is preferably 5 to 25, particularly preferably 8 to 15 μm.

If the multilayer films according to the invention need to have low gas permeability, i.e. low oxygen- and moisture-permeability and aroma protection, they comprise a barrier layer E). This barrier layer preferably consists of an ethylene/vinyl alcohol copolymer, which has an ethylene content of 32 to 45 mol %, preferably 35 to 42 mol %. The barrier layer E) is bonded at its respective surfaces to the bonding layer C) or to the surface layer G) respectively by means of a coupling agent D) or F) respectively. The material used for this purpose is preferably a propylene copolymer or a polyethylene, which has been grafted with maleic anhydride.

The surface layer G) is preferably sealable and/or peelable. Therefore, this sealable layer is preferably produced from a low density polyethylene (LDPE) with a melt flow index (MFI) in the range from 0.5 to 0.8 g/10 min, preferably in the range from 1 to 5 g/10 min (2.16 kg, 190° C. measured to ASTM D1238), or an ionomeric polymer, such as for example a copolymer of an α-olefin and an ethylenically unsaturated monomer with a carboxyl group, the carboxyl groups being present in a quantity of 20 to 100 wt. % as a metal salt, preferably as a zinc salt, or an ethylene/vinyl acetate copolymer with a vinyl acetate content of 3 to 30 wt. %, preferably 4 to 6 wt. %.

According to a particularly preferred embodiment, the sealing layer is also peelable. To this end, a mixture of LDPE and a polybutylene (PB) is preferably used as the layer material. To this end, the mixture contains 15 to 30 wt. %, preferably 20 to 28 wt. %, of polybutylene. Preferably, the polybutylene has a melt flow index (MFI) in the range from 0.3 to 2.0 g/10 min (190° C. and 216 kg to ASTM D1238).

Preferably, the thickness of the surface layer lies in the range from 10 to 50 μm, preferably from 15 to 30 μm.

If LDPE is used as a polymer to produce the sealing layer and the multilayer film comprises a barrier layer, then as a rule a coupling agent layer is necessary to bond the barrier layer and the sealing layer, if ethylene/vinyl alcohol copolymer is not used as barrier layer material. A polyolefin, preferably a polyethylene grafted with maleic anhydride, may be used as coupling agent material. However, it is also possible to use a mixture of LDPE and LLDPE in the ratio of 3:1 to 4:1 as coupling agent. The thickness of the particular coupling agent layer lies in the range from 2 to 8 μm, advantageously in the range from 3 to 6 μm.

The surface layer G) may contain conventional and known slip agents and antiblocking agents, such as for example erucamide, polyalkylsiloxanes, such as for example polydimethylsiloxane and/or silicon dioxide. All or only individual layers may contain stabilisers and further additives of known type.

In addition, layer B) may contain 0.5 to 2 wt. % of a white pigment, such as for example kaolin, calcium carbonate, talcum, titanium dioxide or mixtures thereof. Such inorganic pigments are added to the polymer from which layer B) is produced, preferably in the form of a masterbatch which consists of 30 to 50 wt. % recycled multilayer film material according to the invention.

The multilayer films, which are suitable as lidding films, are preferably produced by the conventional blown film coextrusion process or by

cast film coextrusion, insofar as this concerns the sequence of layers C) to G), and preferably bonded by an extrusion lamination step to the polyolefin or polyester layer A), which is optionally preferably foamed. To this end, layer A) and the multilayer film, consisting of layers C) and G), are brought together in such a way that layer B) is extruded therebetween. Directly after extrusion, sufficient pressure is exerted on the laminate produced in this way for layers A) to G) to be sufficiently bonded together.

However, it is also possible to produce such multilayer films by coextrusion, layer A) also being coextruded at the same time as the other layers, optionally with omission of layer C), and optionally expanded in the case of layer A).

The flexural strength of the non-shrinkable multilayer films, which are used as lidding films, is preferably so great that they withstand the shrinkage forces of the heat-shrinkable multilayer films according to the invention, from which in each case a packaging tray according to the invention is produced, in such a way that the lid of the package does not bend or arch, but rather remains extensively flat, i.e. planar. In this way, not only is the attractive appearance of the package retained, but also the storability and stackability and presentability thereof are not impaired.

Preferably, appropriate lidding films have a flexural strength (measured to DIN 8075 sigma 3.5%) of 10 to 20 MPa, in order to withstand shrinkage forces of packaging trays of 0.7 MPa to 2 MPa (measured to DIN 53369).

The invention therefore also relates to sealed, heat-shrinkable packages.

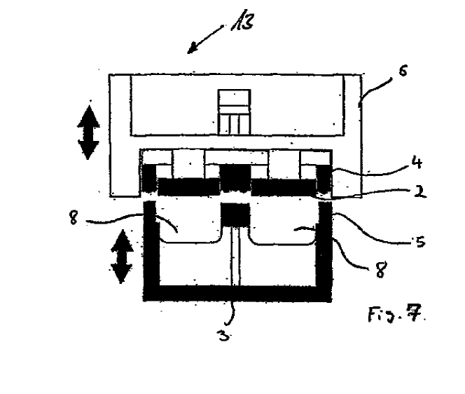

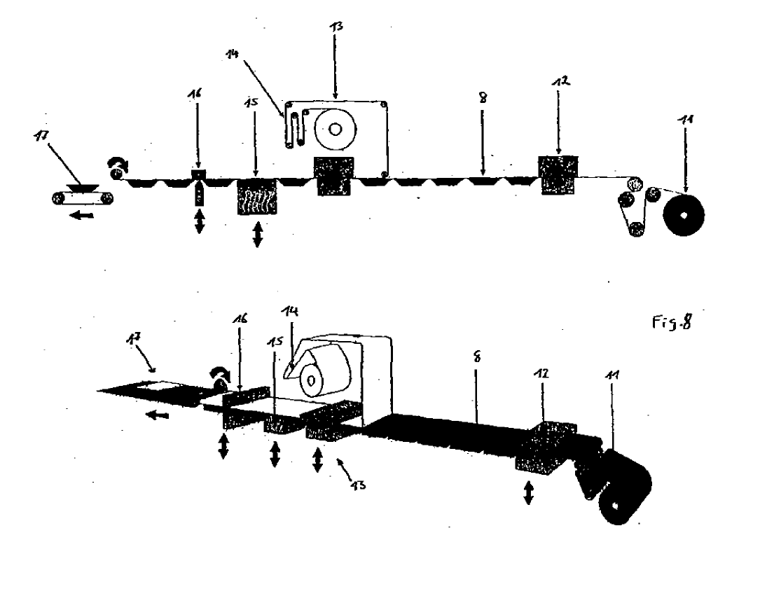

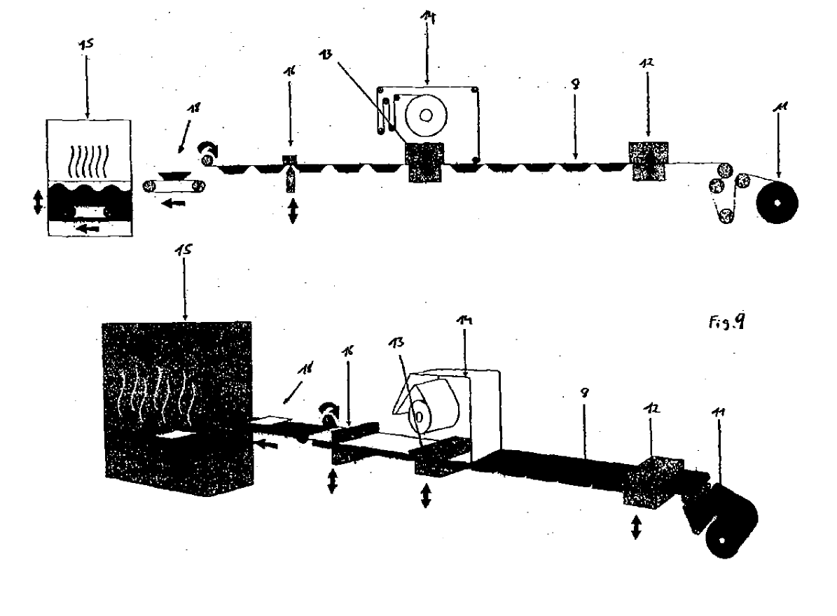

To produce such packages according to the invention, packaging machines are preferably used, particularly preferably those according to FIG. 8 or FIG. 9, which preferably comprise the above-described thermoforming device as thermoforming station and preferably the sealing device described hereinafter, particularly preferably a sealing device according to FIG. 7, as sealing station.

Such packaging machines according to the invention may be used to produce packages consisting of a shrinkable packaging tray and a shrinkable lidding film (top film). Such packages are known as shrink pack packages. FIG. 9 shows a packaging machine for the production of so-called shrink packs. The top film (lidding film) may however also consist of a non-shrinkable film web, as described above. Such packages is known as shrink tray packages. FIG. 8 shows a packaging machine for producing so-called shrink trays.

The sealing device of the packaging machine according to the invention comprises a bottom tool and a top tool, the bottom tool being located under and the top tool being located above the film webs, which are bonded together. The bottom tool and the top tool are pressed against one another in order to seal the top film (=lidding film) to the bottom film. Sealing of the two film webs to one another takes place under the influence of temperature. According to the invention, the bottom tool and/or the top tool is cooled. This cooling may proceed, for example, through circulation of a cooling medium through channels incorporated into the bottom and/or top tool. Water or media known from refrigerators are suitable as the cooling medium. Preferably, the top film and/or the packaging trays are cooled in such a way that no uncontrolled shrinkage of the respective film starts, i.e. the temperature of the respective film web must never reach or exceed the temperature at which shrinkage starts.

Preferably, at least the bottom tool, and particularly preferably also the top tool, is vertically displaceable.

Also preferably, the top or bottom tool comprises a sealing means, for example a sealing frame, which is heated. Heating proceeds as a rule by electrical heating. In the present invention, heating should advantageously be restricted to the sealing means, so that unnecessary cooling of the respective tool is not necessary.

On the tool which does not comprise the sealing frame there is preferably arranged a sealing counterframe. Preferably, the sealing counterframe comprises a rubber support. The counterframe is also preferably cooled and particularly preferably is likewise vertically displaceable.

The top tool is preferably arranged so as to be vertically displaceable. The top tool is preferably also cooled, in order to prevent it from heating up over time and thereby effecting undesired shrinkage of the optionally shrinkable top film. This embodiment is particularly advantageous when the top film is a shrink film.

Preferably, the sealing device comprises a cooling plate, which is arranged particularly preferably in the area of the top film. This cooling plate is preferably likewise arranged so as to be vertically displaceable. If the top film is sealed onto a plurality of packaging trays simultaneously, a cooling plate is preferably arranged in each case in the area of each packaging tray.

The present invention also provides a method of producing shrinkable thermoformed packages from a packaging tray according to the invention and a top film (lidding film), at least the packaging tray being produced from a shrinkable multilayer film according to the invention by thermoforming, in which the film web is firstly heated up in part and is cooled in part prior to and during thermoforming and in which the top film and/or the packaging tray is/are cooled during sealing of the top film on the packaging tray.

When sealing the packaging elements, of which at least one element is produced from a shrink film according to the invention, heat for sealing is input from the side of the package remote from the shrink film. Preferably, in this method according to the invention, heat is input during sealing from underneath or from above.

The following statements apply to both methods according to the invention.

It was extremely surprising and unexpected for the person skilled in the art that packaging trays with straight edges may be produced with such a method and/or that no undesired shrinkage occurs after thermoforming. In this way, packaging containers may be produced in a completely new presentation and with a highly reproducible size. The method according to the invention also prevents the occurrence of undesired shrinkage of the shrink film initiated by the sealing tool.

As already explained, the film web is preferably clamped in place prior to thermoforming. Preferably, the film web is clamped in place with a clamping frame. This clamping frame is particularly preferably cooled and most preferably arranged so as to be vertically displaceable. A cooled clamping frame has the advantage that the subsequent sealing area is at least virtually stress-free, which leads to fewer leaks in the sealing area.

Also preferably, the film web according to the invention is heated prior to thermoforming. Preferably, heating and cooling take place with a time offset, heating preferably taking place prior to cooling. Also preferably, one surface of the film web is heated and the opposing surface is cooled. In a further preferred embodiment of the method according to the invention, heating and cooling proceed simultaneously, some areas of the film web being heated and some areas being cooled. Particularly preferably, the film web is pressed or sucked in the direction of the heating or cooling means, in order to achieve the best possible heat transfer. If a plurality of packaging trays are to be produced simultaneously, a heating means is preferably assigned to each packaging tray to be produced. In this way, the heat required may be introduced into the film web in a locally highly targeted manner.

As already explained, thermoforming may proceed in any manner familiar to a person skilled in the art. Preferably, however, thermoforming is effected by overpressure and/or reduced pressure (vacuum). It is also preferable for thermoforming to be performed with a male mould or for thermoforming to be male mould-assisted, wherein the male mould and the heating means may be one component.

According to the invention, the film web is cooled at least in areas prior to, during and/or after thermoforming. In particular, the area which has been thermoformed is cooled during and/or after thermoforming until no undesired recovery of the thermoformed area any longer takes place. As a rule, this is achieved at temperatures of below the plasticisation temperature of the respective film.

During sealing, the sealing tool facing the shrink film according to the invention is preferably cooled. This embodiment of the method according to the invention has the advantage that the tool facing the shrink film does not activate shrinkage of the shrink film in undesired manner. When using two shrinkable films as lidding film and in the form of the packaging tray, preferably both tools are cooled.

Preferably, at least the shrinkable film web according to the invention is fixed in place prior to and/or during sealing. Preferably, fixing proceeds with the sealing tools. Also preferably, fixing of the shrinkable film web is effected by means of the chains with which the film web is conveyed along the packaging machine.

The invention is explained in detail with reference to FIGS. 1 to 9. These explanations are given merely by way of example and do not restrict the general concept of the invention. The explanations apply to the packaging tray according to the invention, the package according to the invention, the method according to the invention and the devices according to the invention, such as thermoforming device, sealing station and packaging machine.

FIG. 7 shows a sealing device, which is preferably used for the packaging machine according to FIG. 8 or according to FIG. 9.

FIG. 7 shows the sealing device 13, which consists of a top tool 6 and a bottom tool 3. The sealing device is part of a packaging machine. The top film 14 (lidding film, not shown) and the shrinkable film web 1 (not shown), into which packaging trays 8 are worked by thermoforming, are arranged between the top and the bottom tool. The top film 14 (=lidding film) is likewise shrinkable in the present case. The film web 1 is fixed and conveyed by two chains (not shown) in a packaging machine (not shown). The top film 14 is sealed to the film web 1, in order to close the packaging trays 8. The top film 14 is not fixed by chains or the like and is conveyed, as known, by its bond with the bottom film 1. As shown by the double-headed arrow, the top tool is vertically displaceable. Arranged on the top tool is the heated sealing frame 4, which is pressed against the sealing counterframe 5 during sealing. In this way, the film webs 1, 14 are pressed against one another. Due to the resultant pressure and the elevated temperature, the top film is sealed to the edge of the packaging trays 8. In the area of each packaging tray, a cooling plate 2 is arranged on the top tool, preventing heating of the top film outside the sealing area. This embodiment is of particular interest in the case of shrinkable top films. The cooling plates 2 are likewise vertically displaceable. The bottom tool is also vertically displaceable, as indicated by the double-headed arrow. The bottom tool is also cooled in the present case, in order to prevent undesired shrinkage of the packaging tray during sealing. If the top film is not shrinkable, it is possible as a rule to dispense with the cooling plate 2 and cooling of the top tool 6.

FIG. 8 shows a packaging machine for producing a shrink tray, i.e. a package with a shrinkable packaging tray which is closed with a non-shrinkable, comparatively rigid lidding film. A film web is unreeled from a roll 11 and, in the thermoforming device 12, packaging trays 8 are formed in the film web. These packaging trays 8 are then filled with a product to be packaged and then closed with a lidding film 14 in the sealing station 13. In the present case, the film web 11 consists of a shrinkable film, while the film web 14 is not shrinkable and is relatively rigid, such that it acts as a tray. After sealing, the packaging tray is shrunk in a shrinking device 15, only the thermoformed packaging tray coming into contact with a hot medium, for example hot air, steam or water. The shrunk packages produced in this way are then separated using the cutting device 16 and conveyed away as a finished package 17. The respective double-headed arrows show that one or two units of the respective station may be raised or lowered.

FIG. 9 shows a packaging machine for producing a shrink pack, in two views. A shrink pack consists of a shrinkable top and a shrinkable bottom film. Once again, the shrinkable film web is unreeled from a roll 11 and the packaging trays 8 are formed in the film web by thermoforming in a thermoforming station 12. Once the packaging trays have been filled with a product to be packaged, not shown, the packaging tray is closed with a film web 14 in the sealing station 13. In the present case, the lidding film is likewise a shrinkable film. In a following method step, the packages are separated in a cutting station 16. The packages 18 produced in this way are shrunk in a shrinking tunnel, in which they are exposed on all sides to boiling water. The respective double-headed arrows show that one or two units of the respective station may be raised or lowered.

A further aspect of the invention therefore also relates to a packaging machine according to the invention for processing a thermoformable, heat-shrinkable multilayer film, preferably the one according to the invention, comprising
(a) an above-described device for producing thermoformed packaging trays from a heat-shrinkable film web, preferably according to the invention, with a thermoforming tool according to the invention, the thermoforming tool being cooled during thermoforming; and
(b) an above-described sealing device with a bottom tool and top tool, the bottom tool and/or top tool being cooled during sealing.

The preferred embodiments described separately above in connection with the device for producing thermoformed plastics packaging trays or with the sealing device also relate to the packaging machine according to the invention.

A further aspect of the invention relates to a method of producing a package from a thermoformable, heat-shrinkable multilayer film, in particular the one according to the invention, comprising the steps of
(i) producing a thermoformed, heat-shrinkable packaging tray as described above by thermoforming a film web of a thermoformable, heat-shrinkable multilayer film, preferably the one according to the invention, the above-described parameters being observed and
(ii) producing a sealed, heat-shrinkable package as described above by sealing a heat-shrinkable lidding film or a non-heat-shrinkable lidding film onto the thermoformed, heat-shrinkable packaging tray obtained in step (i), the above-described parameters being observed.

The preferred method variants described separately above in connection with the device for producing thermoformed packaging trays or with the sealing device and/or packaging machine also relate to this method according to the invention for producing a package.

By means of the above-described packaging machine or by the above-described method, a sealed, heat-shrinkable package is obtained or a sealed, heat-shrinkable package is obtainable, which comprises the thermoformed packaging tray as one packaging element and an optionally heat-shrinkable lidding film as another packaging element, the two packaging elements being sealed together at the edges. Since the shrinkage process is initiated neither by the thermoforming nor by the heat-sealing, the heat shrinkage properties of the packaging tray and optionally of the lidding film are substantially unaffected even after heat-sealing. Preferably, both the optional heat-shrinkability of the packaging tray in the thermoformed area and the heat-shrinkability of the lidding film in each case in the lengthwise and transverse directions amount to at least 20%, preferably at least 25%, more preferably at least 30%, still more preferably at least 35%, most preferably at least 40% and in particular at least 45%.

The resultant sealed, heat-shrinkable package according to the invention is finally shrunk as explained above, such that both the thermoformed packaging tray and optionally the lidding film contract and come to rest closely against the packaged product. The shrinkage process is initiated by an input of heat, for example in a thermal chamber.

The invention also relates to a shrunk package, which is obtainable by the above-described shrinkage of the sealed, heat-shrinkable package.

The atmosphere displaced by the shrinkage process may escape, for example, through a small opening in the package, the opening finally being closed. Alternatively, the package may be evacuated during or after sealing.

A further aspect of the invention relates to a packaging system comprising the multilayer film according to the invention and the packaging machine according to the invention.

### Method of Testing Shrinkability

The shrinkability of a film according to the invention is measured by drawing a 10×10 cm hairline cross on the film sample to be tested with a film pen, one bar of the cross being drawn in machine direction (md), i.e. extrusion direction, and the second bar of the hairline in cross-machine direction (cmd). The water bath, in which the film sample is immersed for 6 sec, has a temperature of 93° C.

After 6 sec, the sample is removed and, through measurement, the shortening of the hairline cross is stated in percent for the respective direction.

### REFERENCE NUMERALS

1 Film web
2 Cooling means
3 Thermoforming tool, bottom tool
4 Holding means, clamping frame
5 Cooling means
6 Bottom of the packaging tray, double-headed arrow
7 Heating means, heating plates, heating element, heating cartridge
8 Packaging tray
9 Pack edges
10 Pack bottom
11 Film roll
12 Thermoforming station
13 Sealing station
14 Top film
15 Shrinking station, shrinking tunnel
16 Cutting station
17 Finished, shrunk package
18 Package prior to shrinkage
19 Top tool

1. A thermoformable multilayer film with heat-shrinkability in the lengthwise and transverse directions of in each case at least 20%, said heat-shrinkability being substantially unaffected by thermoforming.

2. A multilayer film according to claim 1, wherein said film is heat-sealable.

3. A thermoformable, heat-shrinkable multilayer film, comprising the following layers:
a backing layer (T) based on at least one thermoplastic polymer;
a coupling agent layer (H₁) based on at least one polymer with a melt flow index MFI in the range from 0.1 to 2.0 g/10 min, determined to DIN ISO 1133 at 190° C. and 2.16 kg, its layer thickness being greater than the layer thickness of at least one of the layers directly adjoining the coupling agent layer (H₁);
optionally an oxygen-tight barrier layer (B);
optionally a coupling agent layer (H₂) based on at least one polymer with a melt flow index MFI in the range from 0.1 to 2.0 g/10 min, determined to DIN ISO 1133 at 190° C. and 2.16 kg, its layer thickness being greater than the layer thickness of at least one of the layers directly adjoining the coupling agent layer (H₂); and
a sealing layer (S) which forms one of the two surface layers of the multilayer film and is based on at least one thermoplastic polymer.

4. A multilayer film according to claim 3, wherein the layer thickness of the coupling agent layer (H₁) is in each case greater than the layer thickness of the two layers directly adjoining the coupling agent layer (H₁), and/or the layer thickness of the coupling agent layer (H₂) is in each case greater than the layer thickness of the two layers directly adjoining the coupling agent layer (H₂).

5. A multilayer film according to claim 3 wherein the coupling agent layer (H₁) and the optionally present coupling agent layer (H₂), identically or differently, exhibit a layer thickness of at least 20 μm.

6. A multilayer film according to claim 3, wherein at least one coupling agent layer is based on an ethylene/vinyl acetate copolymer.

7. A multilayer film according to claim 6, wherein the ethylene/vinyl acetate copolymer, identically or differently, exhibits a vinyl acetate content in the range from 3 to 18 mol %.

8. A multilayer film according to claim 3, wherein the backing layer (T) is based on at least one polyolefin, olefin copolymer, polyester or a mixture thereof.

9. A multilayer film according to claim 8, wherein the backing layer (T) is based on at least one polymer selected from the group consisting of polyethylene, ethylene copolymer, polypropylene and propylene copolymer.

10. A multilayer film according to claim 3, wherein the backing layer (T) exhibits a layer thickness in the range from 5 to 100 μm.

11. A multilayer film according to claim 3, wherein the sealing layer (S) is based on at least one polymer selected from the group consisting of polyolefins, olefin copolymers, polyalkyl methacrylates, alkyl methacrylate copolymers, ionomers and mixtures thereof.

12. A multilayer film according to claim 3, wherein the sealing layer (S) exhibits a layer thickness in the range from 5 to 25 μm.

13. A multilayer film according to claim 3, comprising a barrier layer (B) which is based on polyvinylidene chloride, a vinylidene chloride copolymer, a mixture thereof, or an ethylene/vinyl alcohol copolymer.

14. A multilayer film according to claim 13, wherein said barrier layer (B) exhibits a layer thickness in the range from 5 to 50 μm.

15. A multilayer film according to claim 3, wherein the backing layer (T) forms the other one of the two surface layers.

16. A multilayer film according to claim 3, wherein said multilayer film exhibits heat-shrinkability in the lengthwise and transverse directions of in each case at least 20%, said heat-shrinkability being substantially unaffected by thermoforming.

17. A multilayer film according to claim 3, having a draw ratio of 1:5 to 1:3 in the lengthwise direction and of 1:5 to 1:3 in the transverse direction.

18. A multilayer film according to claim 3, wherein the mutually directly adjacent layers are crosslinked together.

19. A multilayer film according to claim 3, having a total film thickness in the range from 50 to 250 μm.

20. A thermoformed, heat-shrinkable packaging tray comprised of the multilayer film of claim 3.

21. A method of producing a thermoformed, heat-shrinkable packaging tray comprising thermoforming a thermoformable, heat-shrinkable multilayer film of claim 3 under conditions in which the heat-shrinkability is substantially unaffected in the thermoformed area.

22. A thermoformed, heat-shrinkable packaging tray comprising a heat-shrinkable multilayer film of claim 1, the heat-shrinkability in the thermoformed area amounting in each case to at least 20% in the lengthwise and transverse directions.

23. A package formed of the heat-shrinkable packaging tray of claim 22.

24. A method for packaging a foodstuff which comprises packaging said foodstuff in the packaging tray of claim 22.

25. A method of producing a package comprising the method according to claim 21 and heat-sealing of the resultant thermoformed, heat-shrinkable packaging tray with a heat-shrinkable lidding film under conditions in which both the heat-shrinkability of the packaging tray in the thermoformed area and the heat-shrinkability of the lidding film are substantially unaffected.

26. A method of producing a package comprising the method according to claim 21 and heat-sealing of the resultant thermoformed, heat-shrinkable packaging tray with a non-shrinkable lidding film under conditions in which the heat-shrinkability of the packaging tray is substantially not triggered.

27. A method according to claim 26, wherein the flexural strength of the lidding film corresponds to the shrinkage forces of the heat-shrinkable packaging tray.

28. A package comprising a thermoformed, heat-shrinkable packaging tray according to claim 22 and an optionally heat-shrinkable lidding film, the heat-shrinkability of the packaging tray in the thermoformed area and the optional heat-shrinkability of the lidding film amounting in each case in the lengthwise and transverse directions to at least 20%.

29. A method of heat-shrinking a package according to claim 28 comprising the input of heat.

30. A packaging machine for processing a multilayer film of claim 1, comprising
(a) a device for producing thermoformed packaging trays from a heat-shrinkable film web with a thermoforming tool, the thermoforming tool comprising cooling means, and
(b) a sealing device with a bottom tool and top tool, the bottom tool and/or top tool being cooled during sealing.

31. (canceled)

32. A packaging machine according to claim 30 adapted to clamp a film web between a holding means and the thermoforming tool, the holding means optionally being coolable by cooling means and optionally being arranged so as to be vertically displaceable.

33. A packaging machine according to claim 30, wherein the thermoforming tool comprises a heating means, said heating means optionally being a heating plate, with which the film web may be heated up, the heating plate optionally taking the form of a thermoforming male mould.

34. A packaging machine according to claim 30, wherein the thermoforming tool comprises a vacuum and/or pressure means for thermoforming the film web, in order to improve contact between the film web and the heating means.

35. A packaging machine according to claim 30, wherein said bottom tool of said sealing device comprises a cooling means.

36. A packaging machine according to claim 30, wherein said bottom tool of said sealing device is vertically displaceable.

37. A packaging machine according to claim 30, wherein said sealing device comprises sealing bars, which are optionally heatable.

38. A packaging machine according to claim 30, wherein said top tool of said sealing device comprises a cooling plate, optionally one per package to be produced.

39. A packaging machine according to claim 38, wherein the top tool (6) and/or the cooling plates (2) is/are arranged so as to be vertically displaceable.

40. A packaging machine according to claim 30, wherein the sealing device comprises a sealing counterframe (5), which is optionally arranged on the bottom tool (3).

41. A packaging machine according to claim 40, wherein the sealing counterframe (5) is cooled.

42. A packaging machine according to claim 40 wherein the sealing counterframe (5) is adapted to be raised and lowered.

43. A packaging machine according to claim 40, wherein the sealing counterframe (5) comprises a rubber support.

44. A packaging system comprising a thermoformable, heat-shrinkable multilayer film according to claim 1.

45. A method of producing a package from a heat-shrinkable multilayer film of claim 1, comprising the steps of
(i) producing a thermoformed, heat-shrinkable packaging tray by thermoforming a film web of the heat-shrinkable multilayer film, the film web firstly being heated up in part and cooled in part prior to and during thermoforming,
(ii) producing a sealed, heat-shrinkable package by sealing an optionally heat-shrinkable lidding film onto the thermoformed, heat-shrinkable packaging tray obtained in step (i), the lidding film and/or the packaging tray being cooled.

46. A method according to claim 45, wherein, in step (i), the film web is clamped in place prior to thermoforming.

47. A method according to claim 45 wherein, in step (i), the film web is firstly heated up in part and is cooled in part prior to and during thermoforming.

48. A method according to claim 45, wherein, in step (i), a sub-area of the film web is heated up and a sub-area of the film web is cooled.

49. A method according to claim 45, wherein, in step (i), the film web is deformed by overpressure and/or reduced pressure.

50. A method according to claim 45, wherein the packaging tray comprises a sealing area and this sealing area is cooled during heating and/or during thermoforming.

51. A method according to claim 45, wherein a heating means is assigned to each packaging tray.

52. A method according to claim 45, wherein the thermoformed film is cooled for a sufficient time to prevent recovery.

53. A method according to claim 45, wherein, in step (ii), the shrinkable lidding film is fixed in place by sealing tools or chain conveyors.

54. A method of sealing a top film to a packaging tray, the packaging tray and/or the top film being made from a heat-shrinkable film, wherein heat for sealing is input from the side of the package remote from the heat-shrinkable film.

55. A method according to claim 45, wherein heat for sealing is input from above.

56. A method according to claim 53, wherein the ridding film is fixed in place by sealing tools, one of which faces the shrinkable multilayer film, and the sealing tool (6, 3) facing the shrinkable multilayer film is cooled.

57. A method according to claim 45, comprising the further step of
(iii) shrinking the sealed, heat-shrinkable package obtained in step (ii) by input of heat.

58. A thermoformed, heat-shrinkable packaging tray comprising a heat-shrinkable multilayer film of claim 3, the heat-shrinkability in the thermoformed area amounting in each case to at least 20% in the lengthwise and transverse directions.

59. The packaging system of claim 44, further comprising a packaging machine according to claim 30.
